(19) United States
(12) Patent Application Publication
(10) Pub. No.: US 2007/0077812 A1
(43) Pub. Date: Apr. 5, 2007

(54) ELECTRONIC DEVICE ASSEMBLY

(75) Inventor: JEN-YU LIANG, Tu-Cheng,Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,476

(22) Filed: Aug. 11, 2006

(30) Foreign Application Priority Data
Sep. 26, 2005 (CN) 200510100078.1

(51) Int. Cl. H01R 13/73

(52) U.S. Cl. 439/552

(57) ABSTRACT

A connecting device assembly comprises a plug and a socket. The plug comprises a handheld portion and a contact portion. The handheld portion comprises a flange protruding from a distal end thereof adjacent to the contact portion. The socket comprises an inner wall and an end exterior wall. The inner wall defines a receiving groove therein for receiving the flange of the plug, and the receiving groove has a radius not less than an outer radius of the flange. At least one blocking portion formed between the receiving groove and the end exterior wall. The plug is rotatably received in the groove of the socket.

### FIELD OF INVENTION

The invention pertains to an electronic device assembly, and particularly to an electronic device assembly with dependable connecting device.

### DESCRIPTION OF RELATED ART

Presently, most of small-sized electronic devices, such as access points, ought to be engaged with other electronic device via a cable with plugs. But there is no latch mechanism between the electronic device and the plugs, resulting in the plug easily being pulled out of the electronic device accidentally during use.

Therefore, a need exists in the industry to overcome the aforementioned deficiencies and inadequacies.

### SUMMARY OF THE INVENTION

In an exemplary embodiment, a connecting device assembly comprises a plug and a socket. The plug comprises a handheld portion and a contact portion. The handheld portion comprises a flange protruding from a distal end thereof adjacent to the contact portion. The socket comprises an inner wall and an end exterior wall. The inner wall defines a receiving groove therein for receiving the flange of the plug, and the receiving groove has a radius not less than an outer radius of the flange. At least one blocking portion formed between the receiving groove and the end exterior wall. The plug is rotatably received in the groove of the socket.

Other advantages and novel features will become more apparent from the following detailed description of preferred embodiments when taken in conjunction with the accompanying drawings, in which:

### BRIEF DESCRIPTION OF THE DRAWINGS

FIG. 1 is an exploded, isometric view of an electronic device assembly of an exemplary embodiment of the present invention;

FIG. 2 is a partially cut-away, assembled view of the electronic device assembly of the FIG. 1;

FIG. 3 is an exploded, isometric view of an electronic device assembly of another exemplary embodiment of the present invention; and

FIG. 4 is a partially cut-away, assembled view of the electronic device assembly of the FIG. 3.

### DETAILED DESCRIPTION OF THE INVENTION

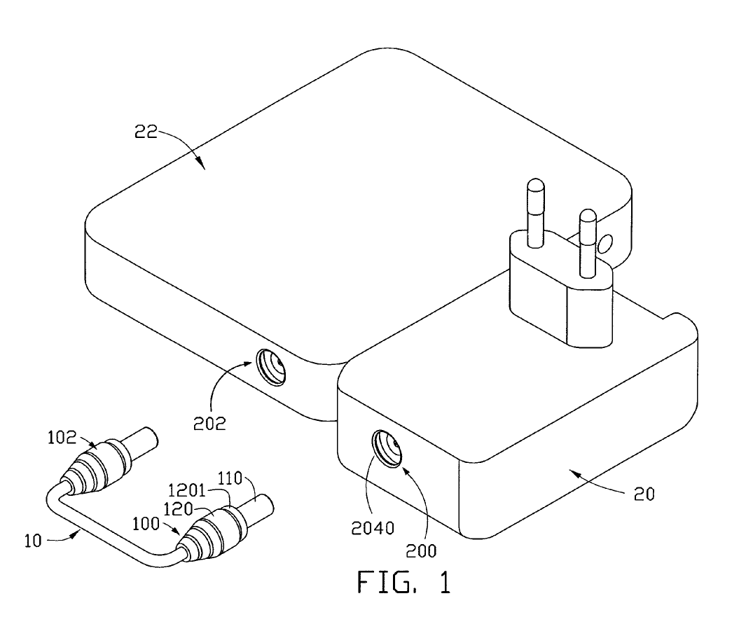

FIG. 1 shows an electronic device assembly of an exemplary embodiment of the present invention. The electronic device assembly comprises a first electronic device 20, and a second electronic device 22 connecting to the first electronic device 20 via a connecting device 10 such as a cable.

The connecting device 10 comprises a first plug 100, and a second plug 102 having the same configuration as the first plug 100. The first plug 100 is connected to the second plug 102 via a cable. The first plug 100 comprises a contact portion 110 for electrically connecting the first plug 100 with an inner circuit of the first electronic device 20, and a handheld portion 120 integrally formed with the contact portion 110. The handheld portion 120 comprises a circular resilient flange 1201 protruding from a periphery of a distal end thereof adjacent to the contact portion 110.

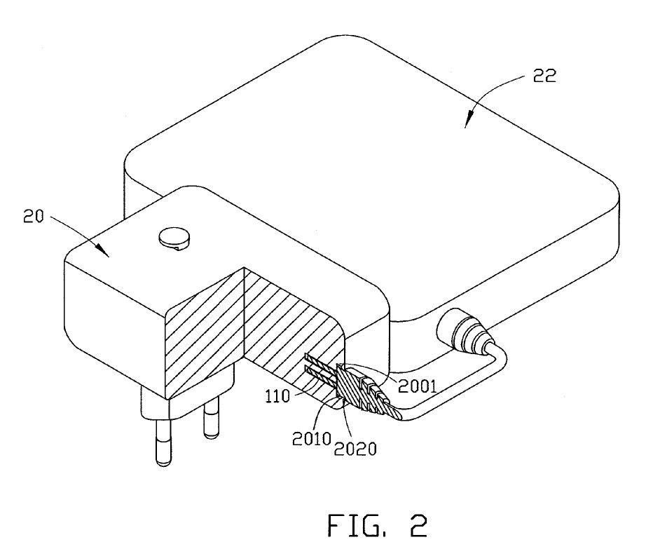

Referring also to FIG. 2, the first electronic device 20 comprises a first socket 200 surrounded by an inner wall 2001. The inner wall 2001 defines a receiving groove 2010 therein for receiving the flange 1201, thereby an annular blocking portion 2020 is formed between the receiving groove 2010 and an end exterior wall 2040. The blocking portion 2020 and the flange 1201 cooperatively prevent the first plug 100 from easily disengaging from the first socket 200. An inner radius of the receiving groove 2010 is generally equal to or slightly greater than an outer radius of the flange 1201. The second electronic device 22 comprises a second socket 202 having the same configuration as the first socket 200.

In assembly, the first plug 100 is inserted into the first socket 200 with the flange 1201 being squeezed through the blocking portion 2020 until the flange 1201 is completely received in the receiving groove 2010. Thus, the first plug 100 is assembled in the first socket 200. In this assembled state, the blocking portion 2020 blocks the flange 1201. The second plug 102 is received in the second socket 202 in the same way.

Because the blocking portion 2020 of the first socket 200 blocks the flange 1201 of the first plug 100, it is difficult for the first plug 100 to be accidentally pulled out of the first socket 200 of the first electronic device 20 during use, which applies to the second plug 102 and the second socket 202 as well. In addition, the plugs 100, 102 are thereby protected from damage. Due to the resiliency of the flanges of the plugs 100, 102, a firm pull by a user is all that is required when it is desired to remove the plugs 100, 102 from the sockets 200, 202.

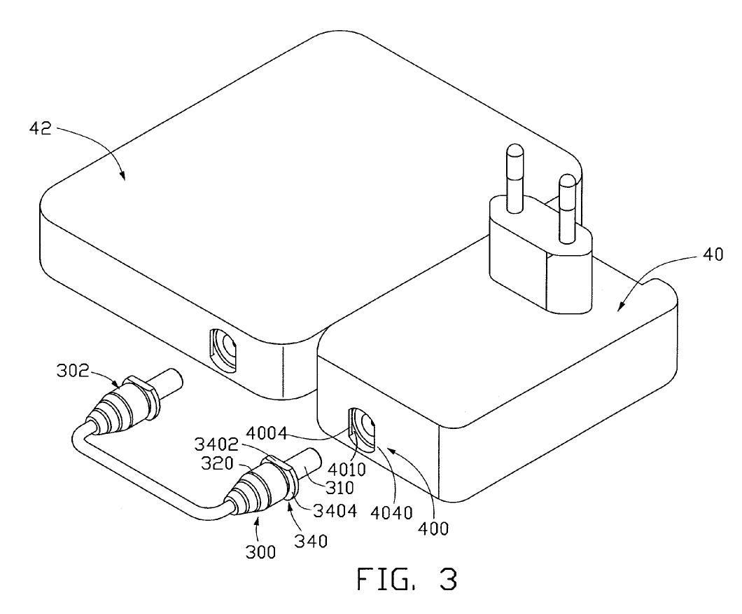

FIG. 3 shows an electronic device assembly of another exemplary embodiment of the present invention. The electronic device assembly comprises a first electronic device 40, and a second electronic device 42 connecting with the first electronic device 20 via a connecting device 30.

The connecting device 30 comprises a first plug 300, and a second plug 302 having the same configuration as the first plug 300. The first plug 300 is connected to the second plug 302 via a cable. The first plug 300 comprises a contact portion 310 and a handheld portion 320 integrally formed with the contact portion 310. The contact portion 310 electrically connects the first plug 300 with an inner circuit of the first electronic device 40. The handheld portion 320 comprises a flange 340 encircling a distal end thereof adjacent to the contact portion 310. The flange 340 comprises a pair of opposite planar portions 3402, and a pair of opposite arched portions 3404 interconnected with the planar portions 3402.

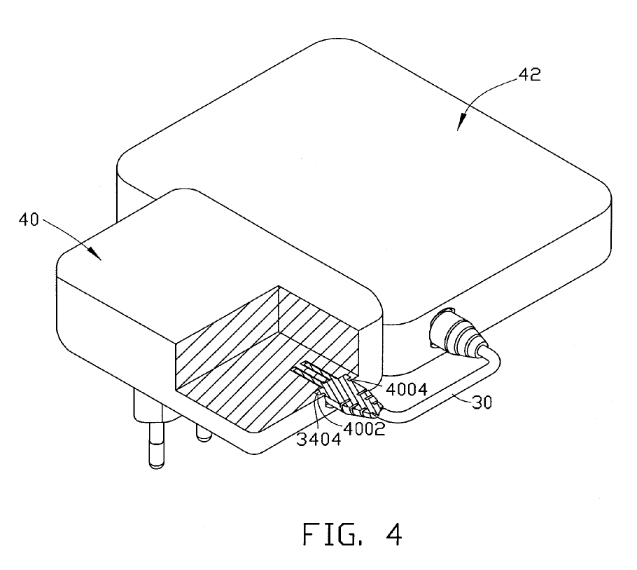

Referring also to FIG. 4, the first electronic device 40 defines a first socket 400. The first socket 400 is surrounded by an annular inner wall 4002. An annular receiving groove 4010 is defined in the inner wall 4002, and a pair of planar blocking portions 4004 is formed between the receiving groove 4010 and an end exterior wall 4040. A distance between the blocking portions 4004 is equal to or slightly greater than a distance between the planar portions 3402. A distance between the blocking portions 4004 is less than a distance between outer surfaces of the two arched portions 3404.

In assembly, the first plug 300 is inserted into the first socket 400 only in a particular angular position where the arched portions 3404 are allowed to be guided through the blocking portions 4004. After the arched portions 3404 pass through the blocking portions 4004, the first plug 300 is rotated through an angle until the arched portions 3404 are blocked by the blocking portions 4004 such that the first plug 300 is reliably prevented from being disengaged from the first socket 400 unless the first plug 300 is positively rotated back to the aforementioned angular position. Thus, the first plug 300 is assembled in the first socket 400. The second plug 302 is received in the second socket 402 in the same way.

The first plug 300 can be detached from the first socket 400 only when the first plug 300 is rotated through a proper angle. Therefore, when assembled, it is difficult for the first plug 300 to be accidentally pulled out of the first socket 400 of the first electronic device 40 during use. In addition, the first plug 300 can thereby be protected from damage.

While exemplary embodiments have been described above, it should be understood that they have been presented by way of example only and not by way of limitation. Thus the breadth and scope of the present invention should not be limited by the above-described exemplary embodiments, but should be defined only in accordance the following claims and their equivalents.

What is claimed is:

1. A connecting device assembly, comprising:
a plug, comprising a handheld portion and a contact portion, the handheld portion comprising a resilient flange protruding from a distal end thereof adjacent to the contact portion; and
a socket, comprising an inner wall; wherein the inner wall defines a receiving groove therein for receiving the flange of the plug, and the receiving groove has a radius not less than an outer radius of the flange; an end exterior wall; and at least one blocking portion formed between the receiving groove and the end exterior wall,
wherein the flange of the plug is rotatably received in the receiving groove of the socket.

2. The connecting device assembly as claimed in claim 1, wherein the flange is circular.

3. The connecting device assembly as claimed in claim 2, wherein the blocking portion is annular.

4. The connecting device assembly as claimed in claim 1, wherein the flange comprises a pair of opposite planar portions and a pair of opposite arched portions interconnected with the planar portions.

5. The connecting device assembly as claimed in claim 4, wherein the blocking portion of the socket further comprises a pair of planar blocking portions formed between the receiving groove and the end exterior wall.

6. The connecting device assembly as claimed in claim 5, wherein a distance between the planar blocking portions of the socket is equal to or slightly greater than a distance between the two planar portions of the flange, and a distance between the planar blocking portions of the socket is less than a distance between the outer surfaces of the two arched portions of the flange.

7. An electronic device assembly, comprising:
a plug, comprising a handheld portion and a contact portion, the handheld portion comprising a resilient flange protruding from a distal end thereof adjacent to the contact portion; and
an electronic device, the electronic device defining a socket for receiving the plug, the socket comprising an inner wall; wherein the inner wall defines a receiving groove therein for receiving the flange of the plug, and the receiving groove has a radius not less than an outer radius of the flange; an end exterior wall, and at least one blocking portion formed between the receiving groove and the end exterior wall;
wherein the flange of the plug is rotatably received in the receiving groove of the socket.

8. The electronic device assembly as claimed in claim 7, wherein the flange is circular.

9. The connecting device assembly as claimed in claim 8, wherein the blocking portion is annular.

10. The electronic device assembly as claimed in claim 7, wherein the flange comprises a pair of opposite planar portions and a pair of opposite arched portions interconnected with the planar portions.

11. The connecting device assembly as claimed in claim 10, wherein the blocking portion of the socket further comprises a pair of planar blocking portions formed between the receiving groove and the end exterior wall.

12. The connecting device assembly as claimed in claim 10, wherein a distance between the planar blocking portions of the socket is equal to or slightly greater than a distance between the two planar portions of the flange, and a distance between the planar blocking portions of the socket is less than a distance between the outer surfaces of the two arched portions of the flange.

13. An assembly comprising:
an electronic device of the assembly electrically connectable with another electronic device for functioning, the electronic device comprising a socket exposable at a side of the electronic device and defining an insertion direction perpendicular to the side of the electronic device, a receiving groove defined at inner walls of the socket spaced from the side of the electronic device and extending along a direction perpendicular to the insertion direction of the socket; and
a cable of the assembly electrically connectable between the electronic device and the another electronic device, the cable comprising a plug movably receivable in the socket of the electronic device along the insertion direction and the inner walls of the socket to establish electrical connection between the cable and the electronic device, the plug comprising a resilient flange protruding therefrom corresponding to the receiving groove of the socket so as to be able to movably squeeze into the receiving groove from the side of the electronic device for retaining the plug in the socket when the plug inserts into the socket to be received therein along the insertion direction of the socket for the electrical connection between the cable and the electronic device.
